(19) United States
(12) Patent Application Publication
(10) Pub. No.: US 2009/0304981 A1
(43) Pub. Date: Dec. 10, 2009

(54) Coat for ear bud and method for making the same

(75) Inventor: Chi-Kung Wu, Taichung City (TW)

Correspondence Address: Chi-Kung Wu, P.O. Box 44-2049, Taipei, 106668, TW

(73) Assignee: Kwan Chien Co., Ltd.

(21) Appl. No.: 12/155,407

(22) Filed: Jun. 4, 2008

(51) Int. Cl. B32B 1/06; B32B 1/04; B29C 44/06

(52) U.S. Cl. 428/81; 264/46.5

(57) ABSTRACT

A method for making a coat for ear bud includes a step of preparing a male mold having insertions and a female mold having concavities, spreading a layer of non-foam Polyurethane material to outside of the insertions and an inside of the concavities; a step of filling foam material in the concavities; a step of inserting the insertions into the concavities, and then foaming the foam material, and a step of separating the male and female molds to pick up coats with the non-foam Polyurethane layer coated thereon. The coat for ear buds includes a body having pre-set shape and a layer of non-foam Polyurethane material is attached to outside of the body and a path axially defined through the body.

### BACKGROUND OF THE INVENTION

(1) FIELD OF THE INVENTION

The present invention relates to a flexible coat for an ear bud and a smooth outer layer is securely coated to the outside of the coat. A method for making the coat is disclosed.

(2) DESCRIPTION OF THE PRIOR ART

A conventional coat for an ear bud generally is made by flexible silicone material which cannot provide satisfied flexibility so that when inserting the ear bud into the user's the external auditory canal, the silicone coat may not fit with the shape of the external auditory canal and makes the user feel uncomfortable. Besides, because the coat on the ear bud does not fit with the external auditory canal, gap is defined between the external auditory canal and the coat of the ear bud so that the noise from outside of the ear interrupts the music and the ear bud is easily to loose from the user's ear.

The latest coat for ear buds is made by foam material which is more flexible than the silicone and can fit with the user's the external auditory canal. However, the foam material basically is a porous material and cannot be shaped in a mold set to have a desired shape. Besides, the porous material easily traps dust or even earwax therein which are difficult to be cleaned out from the porous coat.

Some manufacturers develop an outer layer attached to the porous coat so as to prevent the dust and/or earwax from being trapped in the porous coat. However, the outer layer is easily peeled off from the coat and may impede the sound when passing through the outer layer.

The present invention intends to provide a coat for ear buds and the coat is flexible and shaped to fit with the user's the external auditory canal. A smooth outer layer is securely attached with the coat and hides the pores of the coat from dust and/or earwax.

### SUMMARY OF THE INVENTION

The present invention relates to a method for making a coat for ear buds, the method comprises the following steps:

a step of preparing a mold set comprising a male mold and a female mold, the male mold having insertions extending therefrom and the female mold having concavities, spreading a layer of non-foam Polyurethane material to outside of the insertions and an inside of the concavities;

a step of filling foam material in the concavities;

a step of matching the male and female molds to insert the insertions into the concavities, foaming the foam material, and

a step of separating the male and female molds to pick up coats with the non-foam Polyurethane layer coated thereon.

The present invention further discloses a coat for ear buds and the coat includes a body having pre-set shape and a layer of non-foam Polyurethane material is attached to outside of the body. The body is a bullet-shaped member and includes a flat portion and a curved portion. A recess is defined in the flat portion and a path is axially defined through the body and communicates with the recess. The path forms an opening through of the curved portion. The layer of non-foam Polyurethane material is coated on outside of the flat portion, the curved portion, an inside of the recess and an inside of the path.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the mold set used in the method of the present invention;

FIG. 2 is a cross sectional view to show the mold set used in the method of the present invention;

FIG. 3 is a cross sectional view to show the insertion of the male mold and the concavity in the female mold used in the method of the present invention;

FIG. 4 is a cross sectional view to show that foam material is filled in the concavity in the female mold of the present invention;

FIG. 5 is a cross sectional view to show that the insertion is inserted into the concavity in the female mold of the present invention;

FIG. 6 is a cross sectional view of the coat for ear buds of the present invention;

FIG. 7 is a perspective view to show the coat of the present invention, partly removed, and

FIG. 8 shows that the ear bud is received in the coat of the present invention.

### DETAILED DESCRIPTION OF THE PREFERRED EMBODIMENTS

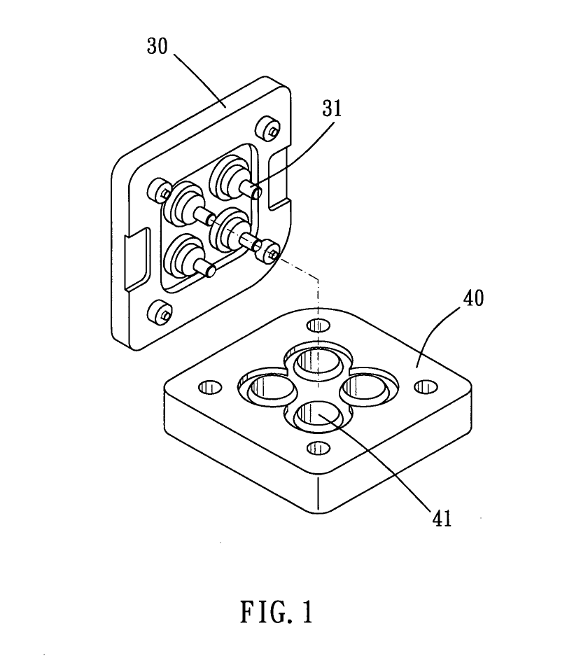

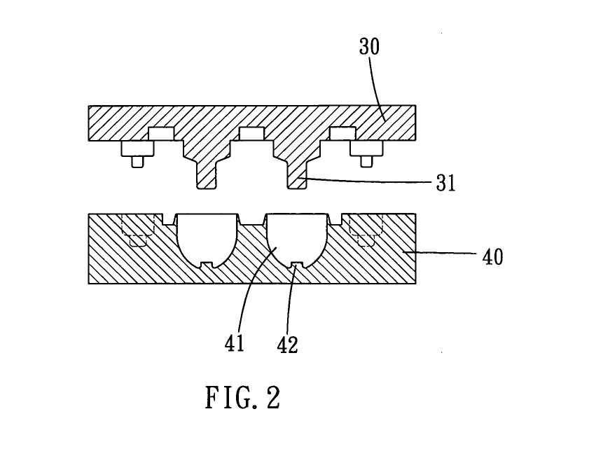

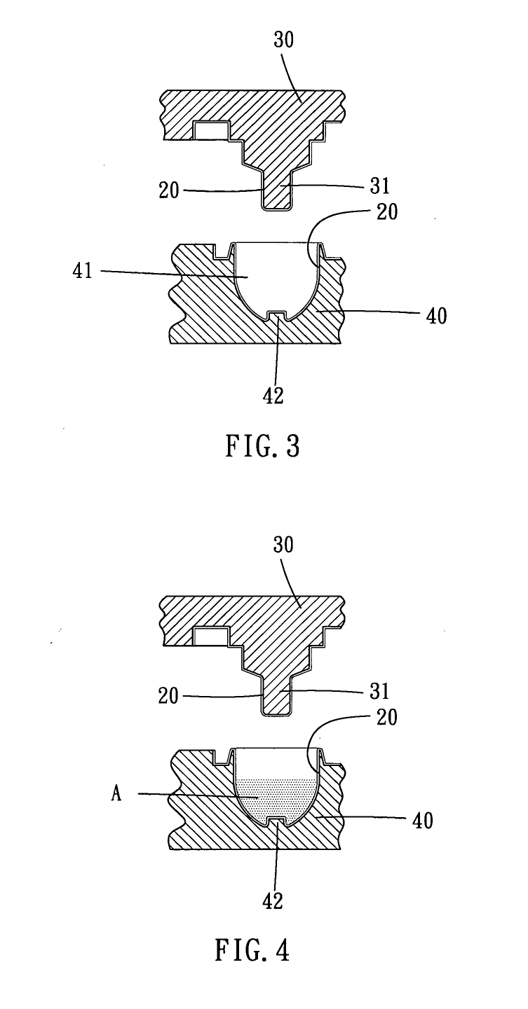

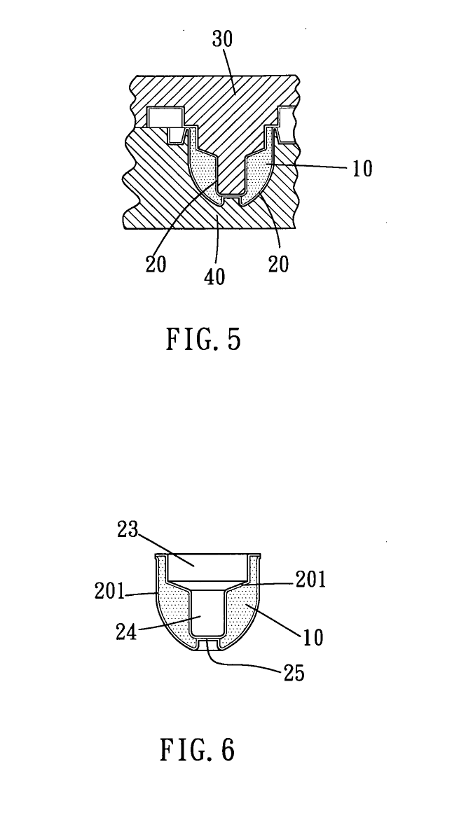

Referring to FIGS. 1 to 6, the method for making a coat for ear buds of the present invention comprises the following steps:

A step of preparing a mold set comprising a male mold 30 and a female mold 40. The male mold 30 has insertions 31 extending therefrom and the female mold 40 have concavities 41. A layer of non-foam Polyurethane material 20 is spread to outside of the insertions 31 and an inside of the concavities 41.

The insertions 31 each are stepped protrusions and a protrusion 42 extends from a center of the inside of each of the concavities 41. A depth of each of the concavities 41 is deeper than a length of the insertion 31 corresponding thereto.

A step of filling Polyurethane foam material “A” in the concavities 41.

A step of matching the male and female molds 30, 40 to insert the insertions 31 into the concavities 41, and then heating and pressing the mold set to foam the Polyurethane foam material “A”. A gap is defined between an end of the insertion 31 and a top of the protrusion 42 when the male and female molds 30, 40 are matched with each other.

A step of separating the male and female molds 30, 40 to pick up coats 1 with the layer of non-foam Polyurethane material 20 coated thereon. The non-foam Polyurethane layer 20 hides the pores of the Polyurethane foam material and includes a smooth outer surface so as to prevent dust and/or earwax from being trapped in the pores. It is noted that the layer of non-foam Polyurethane material 20 is Polyurethanes which does not become yellow after being used.

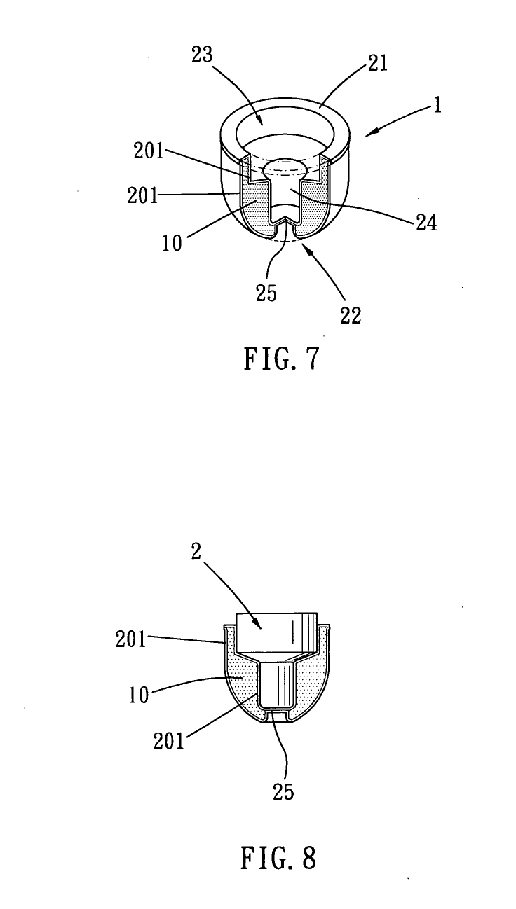

As shown in FIGS. 7 and 8, the coat 1 for ear buds made by the method mentioned above comprises a body 10 having pre-set shape and a layer of non-foam Polyurethane material 201 is attached to outside of the body 10. The body 10 is made by foam material and is a bullet-shaped member which includes a flat portion 21 and a curved portion 22. A recess 23 is defined in the flat portion 21. A path 24 is axially defined through the body 10 and communicates with the recess 23 and forms an opening through the curved portion 22. The layer of non-foam Polyurethane material 201 is coated on an outside of the flat portion 21, an outside of the curved portion 22, an inside of the recess 23 and an inside of the path 24. A vibration membrane 25 is formed in the path 24 to seal the opening of the curved portion 22 and the vibration membrane is formed integrally with the layer of non-foam Polyurethane material 201. The layer of non-foam Polyurethane material 20 is Polyurethanes which does not become yellow after being used.

As shown in FIG. 8, the ear bud 2 is inserted into the path 24 and the received n the recess 23. The layer of non-foam Polyurethane material 20 hides the pores of the Polyurethane foam material and includes a smooth outer surface so as to prevent dust and/or earwax from being trapped in the pores.

The membrane 25 is formed in the gap defined between the end of the insertion 31 and the top of the protrusion 42 when the male and female molds 30, 40 are matched with each other, the membrane 25 is thin and sound can easily pass through the membrane so that the quality is not affected. Besides, the membrane 25 may resonate with the music so that even if the music is weak, the user can enjoy the music.

While we have shown and described the embodiment in accordance with the present invention, it should be clear to those skilled in the art that further embodiments may be made without departing from the scope of the present invention.

What is claimed is:

1. A method for making a coat for ear buds, comprising:
a step of preparing a mold set comprising a male mold and a female mold, the male mold having insertions extending therefrom and the female mold having concavities, spreading a layer of non-foam Polyurethane material to outside of the insertions and an inside of the concavities;
a step of filling Polyurethane foam material in the concavities;
a step of matching the male and female molds to inserting the insertions into the concavities, foaming the foam material, and
a step of separating the male and female molds to pick up coats with the layer of non-foam Polyurethane material coated thereon.

2. The method as claimed in claim 1, wherein the insertions each are stepped protrusions and a protrusion extends from a center of the inside of each of the concavities, a depth of each of the concavities is deeper than a length of the insertion corresponding thereto.

3. The method as claimed in claim 1, wherein the non-foam Polyurethane material is Polyurethanes which does not become yellow after being used.

4. The method as claimed in claim 2, wherein a gap is defined between an end of the insertion and a top of the protrusion when the male and female molds are matched with each other.

5. A coat for ear buds, comprising:
a body having pre-set shape and a layer of non-foam Polyurethane material attached to outside of the body, the body being a bullet-shaped member and including a flat portion and a curved portion, a recess defined in the flat portion, a path axially defined through the body and communicates with the recess and forming an opening through the curved portion, the layer of non-foam Polyurethane material coated on an outside of the flat portion, an outside of the curved portion, an inside of the recess and an inside of the path.

6. The coat as claimed in claim 5, wherein a vibration membrane is formed in the path to seal the opening of the curved portion, the vibration membrane is formed integrally with the layer of non-foam Polyurethane material.

7. The coat as claimed in claim 5, wherein the layer of non-foam Polyurethane material is Polyurethanes which does not become yellow after being used.
